(19) United States
(12) Patent Application Publication
(10) Pub. No.: US 2008/0085111 A1
(43) Pub. Date: Apr. 10, 2008

(54) ILLUMINATION APPARATUS

(75) Inventor: James A. Fowler, Queensbury (GB)

Correspondence Address: WORKMAN NYDEGGER, 60 EAST SOUTH TEMPLE, 1000 EAGLE GATE TOWER, SALT LAKE CITY, UT, 84111, US

(73) Assignee: OPTILUME LTD, Ilkley (GB)

(21) Appl. No.: 11/691,180

(22) Filed: Mar. 26, 2007

(30) Foreign Application Priority Data
Oct. 4, 2006 (GB) GB0619658.8

(51) Int. Cl. G03B 15/03; F21V 33/00

(52) U.S. Cl. 396/199; 362/362

(57) ABSTRACT

An illumination apparatus has a first adaptor, an illumination apparatus body, and a light emitter housing. The first adaptor can be removably attached to a viewing device. The illumination apparatus body is removably coupled to the first adaptor and defines a viewing aperture. The light emitter housing is coupled to the illumination apparatus body and disposed laterally from the viewing aperture. A movable block is disposed in the light emitter housing so as to be movable with respect to the light emitter housing. A light emitter is disposed within the movable block such that the movable block is capable of being moved so that light emitted from the light emitter can be directed toward the viewing center axis of the viewing aperture.

### CROSS-REFERENCE TO RELATED APPLICATIONS

This U.S. patent application claims the benefit of United Kingdom Patent Application GB0619658.8, which was filed on Oct. 4, 2006, which is incorporated herein in its entirety by specific reference.

### BACKGROUND OF THE INVENTION

I. The Field of the Invention

The present invention relates to an illumination apparatus. More particularly, the present invention relates to an illumination apparatus configured for use with a viewing device.

II. The Related Technology

The accurate illumination of teeth and dental materials in dental applications is important so that the color of any dental materials can be matched with the color of the teeth to which the dental material will be associated. As such, it is desirable for a dental material, such as a restoration material, to be closely matched in color with the teeth being repaired so that there is not a noticeable difference. In part, closely matching the color of a dental material with the color of teeth is important so that the patient's teeth appear to be normal.

Conventionally, such color matching has been performed by taking the patient to a source of sunlight, such as a window, and matching the color of the dental restorative material with the color of the patient's teeth. During this procedure, the dental professional is generally trying to obtain a light source of about 5500 Kelvin (i.e., a measure of color temperature), which is generally held to be a standard that most closely corresponds to “noon” sunlight or the level of sunlight at the brightest point in a day. However, this method is susceptible to error, and is typically dependent on factors such as the time of day at which the color matching is undertaken, the amount of sunlight available, and/or the weather. In addition, it is inconvenient to have to restrict color matching to particular times of the day, weather conditions, or locations near windows. If the color matching is incorrect, the patient may crowns, fillings, and/or the like that do not match the natural color of their teeth. Dental restorations that do not match the natural color of surrounding teeth can be aesthetically displeasing and distressing to the patient.

One method currently used to overcome this problem is to use a fluorescent light source, such as a lighting cabinet, incorporating one or more fluorescent light sources that purportedly simulate sunlight. However, such lighting cabinets do not actually produce light comparable to sunlight, particularly noon-day sunlight. In addition, the fluorescent light sources have to heat up for a pre-determined period of time before the light being emitted therefrom has a stable color spectrum. Also, fluorescent lights have a relatively limited and short lifespan and/or degrade in color accuracy over time. As such, these conventional devices can result in inaccurate color matching or shade matching between the dental restoration and surrounding teeth.

In addition to the process of matching the color of a restoration material with the color of teeth, dentists provide dental laboratories with digital photographs of teeth which help to correlate the appearance of the restoration material with the surrounding teeth. The lighting level in the locality at the time the photograph is taken can significantly alter the color of the teeth in the resulting image, thereby making color reproduction inconsistent. In an attempt to overcome this problem, it is known to provide a lighting apparatus that can be detachably mounted to the front of the camera lens to provide a continuous and controllable light. An example of such a lighting apparatus is produced by the company DoctorsEyes™ and the light attempts to provide reproducible light and consistent colors. More particularly, the lighting apparatus includes a central ring light which is fitted to the front of the lens with two lateral light panels mounted at acute angles on opposite sides of the ring light. The ring light and lateral light panels include a plurality of white LEDs, and the brightness of the LEDs can be controlled to produce a required level of lighting for photography. However, one problem associated with this type of device is that the LEDs may not provide lighting over the correct spectrum necessary to achieve a color rendering index sufficient to obtain color reproducibility. Thus, such a lighting apparatus with white LEDs may not provide light at about 5500 Kelvin or light that closely corresponds to “noon” sunlight, and resulting photographs may not accurately portray the teeth and/or any dental materials associated with the teeth.

Therefore, it would be advantageous to have an improved illumination apparatus that can be used to provide light at about 5500 Kelvin or light that better approximates “noon” sunlight and can be used with cameras in making photographs of a patient's teeth. Additionally, it would be advantageous to have a camera system including the improved illumination apparatus. Further, it would be advantageous to have a method of using the improved illumination apparatus, especially in dental applications that utilize photographs of teeth.

### BRIEF SUMMARY OF THE INVENTION

Generally, embodiments of the present invention addresses the foregoing needs by providing an improved illumination apparatus that can be used to provide light at about 5500 Kelvin or light that better approximates “noon” sunlight. As such, embodiments of the present invention include an improved illumination apparatus that can provide consistent and continuous light for enhanced visibility when illuminating objects, especially when used in photography. Also, embodiments of the present invention include methods of using the improved illumination apparatus to produce photographs that accurately depict the color of teeth when illuminated by light at about 5500 Kelvin or light that approximates “noon” sunlight.

In one embodiment, the present invention includes an illumination apparatus that has a first adaptor, an illumination apparatus body, and at least one light emitter housing. The first adaptor is configured for being removably attached to a viewing device, such as a camera, video recorder, or loupe. The first adaptor can be annular so at least partially defining a viewing aperture that can be associated with the viewing device such that objects can be viewed through the viewing aperture along a viewing center axis.

The illumination apparatus body is at least indirectly removably coupled to the first adaptor; however, the illumination apparatus can be directly coupled to the first adaptor so that it can be selectively removed therefrom. Also, the illumination apparatus body can cooperate with the first adaptor to at least partially define the viewing aperture. The viewing aperture can be defined by the illumination apparatus body such that the viewing aperture extends from a rear opening in a rear surface of the illumination apparatus body to a front opening in a front surface of the illumination apparatus body.

The illumination apparatus includes at least one light emitter housing coupled to the illumination apparatus body and disposed laterally from the viewing aperture. Additionally, any number of light emitter housings that can be disposed laterally of the viewing aperture and can be coupled to the illumination apparatus body can be included. The light emitter housing includes a light emitter body, a movable block, and a light emitter. Typically, the light emitter body defines the shape of the light emitter housing and includes the movable block and light emitter disposed therein. The movable block is disposed in the light emitter body so as to be movable with respect to the light emitter body, which can include movement at any angle and in any direction. The light emitter is disposed within the movable block such that the movable block is capable of being moved so that light emitted from the light emitter can be directed toward the viewing center axis of the viewing aperture. In part, the ability to move the direction of the emitted light can allow such emitted light to be directed toward the viewing center axis at a plurality of distances from the front opening of the illumination apparatus body. This includes the light being directed to the viewing center axis just in front of the viewing aperture through the light intersecting the viewing center axis at a 45° angle, and can include a position where the light begins to diverge from the viewing center axis. Moreover, the emitted light can be adjusted so as to point straight ahead and congruent with the center viewing axis or even outwardly and away from the center viewing axis.

In one embodiment, the present invention includes an illumination apparatus that has a first annular adaptor, second annular adaptor, illumination apparatus body, and at least one light emitter housing. The first annular adaptor is configured for being removably attached to a viewing device, and at least partially defines a viewing aperture that can be associated with the viewing device such that objects can be viewed through the viewing aperture along a viewing center axis. The second annular adaptor is configured to be removably coupled to the first annular adaptor, and also at least partially defines the viewing aperture. The illumination apparatus body is coupled to the second annular adaptor so as to be integrated therewith. The illumination apparatus body also at least partially defines the viewing aperture such that the viewing aperture extends from a rear opening in a rear surface of the illumination apparatus body to a front opening in a front surface of the illumination apparatus body.

The illumination apparatus includes at least one light emitter housing coupled to the illumination apparatus body and/or second annular adaptor, and disposed laterally from the viewing aperture. The light emitter housing includes a light emitter body, movable block, and a light emitter. The light emitter body defines the shape of the light emitter housing and includes the movable block and light emitter disposed therein. The movable block is disposed in the light emitter body so as to be movable with respect to the light emitter body, which can include movement at any angle and in any direction. The light emitter is disposed within the movable block such that the movable block is capable of being moved so that light emitted from the light emitter can be directed toward the viewing center axis of the viewing aperture.

In one embodiment, the present invention includes a photography system for taking illuminated photographs under continuous light. Such a photography system includes a camera, video recorder, or other viewing device. The photography system also includes a lens device configured to be removably coupled to the viewing device, and has a lens housing including threads in a front surface of the lens housing. Additionally, the photography system includes an illumination apparatus substantially as described herein; however, the first adaptor of the lighting apparatus has threads for being removably attached to the lens device by being screwed into the threads in the front surface of the lens housing.

In one embodiment, the illumination apparatus includes at least one mounting bracket coupled to the illumination apparatus body and/or second adaptor, and coupled to the light emitter housing so as to couple the illumination apparatus body to the light emitter housing. As such, each mounting bracket is disposed in a position lateral from the viewing aperture.

In one embodiment, the light emitter emits light characterized as substantially 5500 Kelvin or light that approximates “noon” sunlight. As such, the light emitter can include a plurality of LEDs that cooperate to emit the light, or a halogen or high intensity discharge (HID) lamp that is filtered to be characterized as substantially 5500 Kelvin.

In one embodiment, the light emitter housing includes a channel defined by the movable block that extends from a rear opening in a rear surface in the light emitter body and/or movable block to a front opening in a front surface of the light emitter body and/or movable block. A fiber optic cable is disposed within the channel such that the light emitted from the light emitting end of the fiber optic cable is directed out of the front opening. Optionally, the light receiving end of the fiber optic cable is optically coupled to a remote light source.

In one embodiment, the illumination apparatus includes at least one of the following: at least one lens disposed in the viewing aperture; at least one locking mechanism associated with the first adaptor that is configured to releasably lock the first adaptor to the viewing device; at least one magnet disposed on one of the first adaptor or the illumination apparatus body and the other of the first adaptor or the illumination apparatus body being comprised of a magnetically responsive material that is magnetically attracted to the magnet; at least one lens disposed in the light emitter housing such that light emitted from the light emitter passes through the at least one lens; or a rotation shaft coupled to the light emitter body that is rotatably inserted into a rotation shaft receiver defined by the movable block such that the movable block is capable of rotating inward toward the viewing center axis at a plurality of distances from the front opening of the illumination apparatus body.

These and other embodiments and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view illustrating an embodiment of a photography system having an illumination apparatus.

FIG. 2A is a front view illustrating an embodiment of an illumination apparatus.

FIG. 2B is a side view illustrating the illumination apparatus of FIG. 2A.

FIGS. 3A-3B show a cross sectional view (FIG. 3A) and front view (FIG. 3B) illustrating an embodiment of a first annular adaptor.

FIGS. 4A-4B show a side view (FIG. 4A) and rear view (FIG. 4B) illustrating an embodiment of a second annular adaptor.

FIGS. 5A-5B show a front view (FIG. 5A) and side view (FIG. 5B) illustrating an embodiment of a mounting bracket.

FIGS. 6A-6C show a cross-sectional side view (FIG. 6A), a cross-sectional front view (FIG. 6B), and a top view (FIG. 6C) illustrating an embodiment of a light emitting housing.

FIGS. 7A-7C show a cross-sectional side view (FIG. 7A), a front view (FIG. 7B), and a top view (FIG. 7C) illustrating an embodiment of a movable block.

FIGS. 8A-8C show a top view (FIG. 8A), a first side view (FIG. 8B), and a second side view (FIG. 8C) illustrating an embodiment of a light emitter cap.

### DETAILED DESCRIPTION OF THE PREFERRED EMBODIMENTS

Generally, embodiments of the present invention include an improved illumination apparatus that can be used to provide light at about 5500 Kelvin or light that better approximates “noon” sunlight and can be used in photography. Additionally, embodiments of the present invention include a camera system including the improved illumination apparatus. Further, embodiments of the present invention include methods of using the improved illumination apparatus to produce photographs that accurately depict the color of teeth when illuminated by light at about 5500 Kelvin or light that better approximates “noon” sunlight.

### I. Illumination Apparatus

Although the following description refers almost exclusively to the illumination apparatus being configured for use on a camera, and particularly for use with a camera in a dental application, it will be appreciated by persons skilled in the art that the illumination apparatus of the present invention can be used on any suitable equipment for any suitable application, such as on a microscope, loupe, and the like.

An illumination apparatus can include a first adaptor, an illumination apparatus body removably coupled to the first adaptor, and at least one light emitter housing coupled to the illumination apparatus body. The first adaptor is configured for being removably attached to a viewing device, such as a camera, video recorder, or loupe. The illumination apparatus body can be removably coupled to the first adaptor and can define a viewing channel that extends from a rear surface of the illumination apparatus body to a front surface of the illumination apparatus body. Accordingly, the illumination apparatus can include a second adaptor that can be coupled with the first adaptor. The viewing channel can include a viewing axis that can be used to visually center the viewing channel with respect to an object being viewed therethrough. A viewing channel can be similar to a viewing aperture, but may not be fully enclosed and may have an open side wall.

The illumination apparatus can include at least one light emitter housing coupled to the illumination apparatus body and disposed laterally from the viewing channel. As such, any number of light emitter housings that can be disposed laterally of the viewing channel and can be coupled to the illumination apparatus body can be included. Each light emitter housing can include a light emitter body, movable block, and a light emitter. Typically, the light emitter body generally defines the shape of the light emitter housing and includes the movable block and light emitter disposed therein. The movable block can be disposed in the light emitter body so as to be movable with respect to the light emitter body at any angle and in any direction.

The light emitter is disposed within the movable block such that the movable block is capable of being moved so that light emitted from the light emitter can be directed toward the viewing axis of the viewing channel. In part, the ability to move the direction of the emitted light can allow such emitted light to be directed toward the viewing axis at a plurality of distances from the front surface of the illumination apparatus body. This can include the light being directed toward the viewing axis just in front of the viewing channel through any position along the viewing axis. For example, the light emitter can be oriented so that the emitted light intersects the viewing axis at a 45° angle. Alternatively, the emitted light can be adjusted so as to point straight ahead and congruent with the viewing axis, or outwardly and away from the viewing axis.

Another illumination apparatus can include a first adaptor, second adaptor, illumination apparatus body, and at least one light emitter housing. The first adaptor can be configured substantially as described herein such that it can be removably attached to a viewing device. The second adaptor can be configured to be removably coupled to the first adaptor, and the first and second adaptors can be annular adaptors. The illumination apparatus body is coupled to or integrated with the second adaptor. Optionally, the illumination apparatus is configured as or includes the second adaptor. The illumination apparatus body defines a viewing aperture having a viewing center axis, and the viewing aperture extends from a rear opening in a rear surface of the illumination apparatus body to a front opening in a front surface of the illumination apparatus body. The illumination apparatus includes at least one light emitter housing coupled to the illumination apparatus body and/or second adaptor, and disposed laterally from the viewing aperture. The light emitter housing includes a light emitter body, movable block, and a light emitter. The light emitter body defines the shape of the light emitter housing and includes the movable block and light emitter disposed therein. The movable block is disposed in the light emitter body so as to be movable with respect to the light emitter body, which can include movement at any angle and in any direction. The light emitter is disposed within the movable block such that the movable block is capable of being moved so that light emitted from the light emitter can be directed toward the viewing center axis of the viewing aperture.

An illumination apparatus as described herein can be included in a photography system for taking illuminated photographs under continuous light. Such a photography system includes a camera, video recorder, or other viewing or imaging device. The photography system can also include a lens device configured to be removably coupled to the viewing or imaging device, and has a lens housing including threads in a front surface of the lens housing. Additionally, the photography system includes an illumination apparatus substantially as described herein; however, the first adaptor of the illumination apparatus can include threads for being removably attached to the lens device by being screwed into the threads in the front surface of the lens housing.

### II. Illumination Apparatus Components

The illumination apparatus of the present invention includes a first adaptor configured for being removably attached to a viewing device. Accordingly, the first adaptor can include a releasable fastener that can attaches to the viewing device. Such a releasable fastener can be any member selected from the group consisting of a friction fit, at least one clamp, an elastic band, magnetic pairs, at least one clip, at least one tie, inter-engaging members (e.g., a screw threaded portion), a screw arrangement, a bolt, a cotter pin, combinations thereof, and the like. Additionally, the releasable fastener can be associated with a locking mechanism such that after the first adaptor is attached to the viewing device the locking mechanism can be engaged to temporarily fasten the first adaptor to the viewing device. Also, the locking mechanism can be releasable such that actuating the locking mechanism can allow for the releasable fastener to be disengaged and the first adaptor can be removed from the viewing device. For example, cameras and lens devices are configured to be removably coupled together by having cooperating screw threading arrangements that screw together so as to engage a locking mechanism that locks the lens device to the camera, and a button can be pushed to disengage the locking mechanism to allow the lens device to be unscrewed from the camera. Such a fastener and locking mechanism can be utilized with the first adaptor and viewing device.

In one embodiment, the first adaptor can be an annular adaptor that at least partially defines a viewing aperture that is associated with a viewing aspect of the viewing device. For example, the first annular adaptor can be configured similarly to the adaptor mechanism of a lens device. While the first adaptor is generally described herein as an annular adaptor, other configurations can be employed, such as a partially annular, square, triangle, or other shaped body.

The first adaptor can be comprised of various materials that can be formed and function to achieve the functions described herein associated with the first adaptor. Accordingly, the first adaptor can be prepared from various plastics, ceramics, composites, metals, and combinations thereof. In one instance, it can be beneficial for the first adaptor to include a magnetically responsive material that can be utilized as part of a fastener system. As such, the first adaptor can include a ferromagnetic material or a magnetic material with opposite polarity compared to a magnet associated with the viewing device, second adaptor, and/or illumination apparatus body.

In one embodiment, at least one magnet is disposed on one of the first adaptor or the illumination apparatus body and the other of the first adaptor or the illumination apparatus body is comprised of a magnetically responsive material that is magnetically attracted to the at least one magnet.

In one embodiment, the illumination apparatus of the present invention includes a second adaptor that can be removably coupled to the first adaptor. The second adaptor can be configured to be removably coupled to the first adaptor substantially as described in connection with the first adaptor being removably attachable to the viewing device. Accordingly, the second adaptor can include a releasable fastener that can attaches to the first adaptor. Such a releasable fastener can be any member selected from the group consisting of a friction fit, at least one clamp, an elastic band, magnetic pairs, at least one clip, at least one tie, inter-engaging members (e.g., a screw threaded portion), a screw arrangement, a bolt, a cotter pin, combinations thereof, and the like. Also, the first and second adaptors can be configured to include a fastening system where each of the first and second adaptor includes a part of the fastening system. Such fastening systems can include fastener pairs substantially similar to the fasteners as described herein. Additionally, the releasable fastener can be associated with a locking mechanism such that after the second adaptor is attached to the first adaptor the locking mechanism can be engaged to temporarily fasten the first and second adaptors together.

In one embodiment, the second adaptor can be an annular adaptor that at least partially defines a viewing aperture that is associated with the viewing aperture of the first adaptor and/or the viewing aspect of the viewing device. Accordingly, the second adaptor can be configured similarly as the first adaptor. While the second adaptor is generally described herein as an annular adaptor, other configurations can be employed, such as a partially annular body.

The second adaptor can be comprised of various materials that can be formed and function to achieve the functions described herein associated with the second adaptor. Accordingly, the second adaptor can be prepared from various plastics, ceramics, composites, metals, and combinations thereof. In one instance, it can be beneficial for the second adaptor to include a magnetically responsive material that can be utilized as part of a fastener system. As such, the second adaptor can include a ferromagnetic material or a magnetic material with opposite polarity compared to a magnet associated with the first adaptor.

In one embodiment, at least one magnet is disposed on one of the first adaptor or the second adaptor and the other of the first adaptor or the second adaptor is comprised of a magnetically responsive material that is magnetically attracted to the at least one magnet.

The illumination apparatus of the present invention can be generally defined by an illumination apparatus body. Such an illumination apparatus body can be configured to have various shapes, sizes, and orientations that can allow for the illumination apparatus to be associated with a viewing device, such as a camera. For example, the illumination apparatus body can have a shape and size that cooperates with the first adaptor and/or the second adaptor. As such, the illumination apparatus body can be substantially annular so as to define a viewing aperture having a viewing center axis. The viewing aperture can extend from a rear opening in a rear surface of the illumination apparatus body to a front opening in a front surface of the illumination apparatus body. While the illumination apparatus body is generally described herein as having a substantially annular cross-sectional profile, other cross-sectional profile configurations can be employed, such as partially annular, square, triangle, other shape, or portions thereof. Moreover, the illumination apparatus body can be comprised of any of the various materials described herein. Optionally, the illumination apparatus body is or is comprised of the second adaptor.

In one embodiment, the illumination apparatus body can define lens receptacles that are disposed within the viewing aperture. As such, various types of lenses can be disposed within the lens receptacles of the viewing aperture. This can allow the viewing aperture to be configured and function similarly to a lens device of a camera system. For example, the lens can be a passive, biplanar, biconvex, plano-convex, convex-concave, meniscus, plano-concave, biconcave, and the like. As such, the light can passively pass through the lens or converge, concentrate, focus, diverge, spread, collimate, or the like.

In one embodiment, the front surface of the illumination apparatus body can include a cap receiver that can receive a cap thereon. The cap receiver can allow for a cap to be placed onto the front surface and fastened thereto so as to close or seal the front opening. By sealing the front opening, the viewing aperture or lenses disposed therein can be protected from the elements. For example, the cap receiver can be configured similarly to a lens device that receives a lens cap as commonly employed in camera systems.

The illumination apparatus includes at least one light emitter housing coupled to the illumination apparatus body and disposed laterally from the viewing aperture. For example, the illumination apparatus can include at least two light emitter housings that are disposed on opposite sides of the illumination apparatus body in positions lateral from the viewing aperture. As such, each light emitter housing can be disposed laterally from the viewing axis so that the light emitter housing does not interfere with viewing an object through the viewing aperture.

The light emitter housing can be defined by a light emitter body. The light emitter body can be a unitary piece or can be multiple pieces that are assembled together. The light emitter body can have various shapes and sizes that can be configured to house a light emitter that can allow for the light emitter body to be associated with the illumination apparatus. Additionally, the light emitter body can be comprised of any of the various materials described herein.

In one embodiment, the illumination apparatus can include at least one light emitter housing that is located at an acute angle to the illumination apparatus body. Such an acute angle can be about 45 degrees. The acute angle can be formed with the viewing aperture and/or the viewing center axis. Alternatively, the acute angle can be formed with a plane formed by the front opening in the illumination apparatus body.

In one embodiment, at least a part of a light emitter housing can be movable relative to the illumination apparatus body. Also, the entire light emitter housing can be movable relative to the illumination apparatus body. This can include being freely movable in 360 degrees or being rotatable along a horizontal plane that intersects the viewing center axis.

In one embodiment, at least one mounting bracket can be coupled to the illumination apparatus body and/or second adaptor, and coupled to the light emitter housing so as to indirectly couple the illumination apparatus body to the light emitter housing. As such, each light emitter housing can be associated with a mounting bracket, and each mounting bracket can be disposed in a position lateral from the viewing aperture. Mounting brackets are well known and any such mounting bracket that can be employed to couple the illumination apparatus body to the light emitter housing can be included in the present invention. For example, in the instance the illumination apparatus is substantially annular and the light emitter housing is substantially round, the mounting bracket can have first and second concave receiving surfaces that receive the illumination apparatus and the light emitter housing, respectively.

The light emitter body can define a chamber that can contain the movable block disposed therein so as to be movable with respect to the light emitter body. As such, the chamber and movable block can be configured similar to a ball and socket that allows the ball (e.g., movable block) to freely rotate or otherwise move with respect to the socket (e.g., chamber). However, the chamber and movable block can be cooperatively configured so that the movable block only rotates in one direction (e.g., laterally or horizontally) with respect to the viewing center axis.

In one embodiment, a rotation shaft is coupled or integrated with the light emitter body. The rotation shaft is rotatably inserted into a rotation shaft receptacle defined by the movable block such that the movable block is capable of rotating inward toward the viewing center axis. Also, the rotation shaft allows for the movable block to rotate outwardly and away from the viewing center axis. As such, the rotation shaft and rotation shaft receptacle cooperate to allow the movable rotation block to rotate any number of degrees, which can be up to 180 degrees.

The illumination apparatus includes at least one light emitter disposed within the movable block. Since the movable block is movable, light emitted from the light emitter is capable of being directed in various directions, such as toward the viewing center axis at a plurality of distances from the front opening of the illumination apparatus body. The light emitter can be configured to emit light characterized as substantially 5500 Kelvin or “noon” sunlight. Accordingly, the light emitter can include a plurality of LEDs that cooperate to emit the light. Alternatively, the light emitter can include a halogen, HID, or other lamp that can be filtered so as to emit the light. Thus, any light and filter combination to achieve the light can be included in the illumination apparatus. An example of a light emitter can be found in U.S. patent application Ser. No. 11/339,288, which is incorporated herein in its entirety by specific reference.

In one embodiment, the light emitter housing includes a channel containing a fiber optic cable as the light emitter. More particularly, the channel is defined by the movable block so as to extend from a rear opening in a rear surface of the light emitter body and/or movable block to a front opening in a front surface of the light emitter body and/or movable block. The fiber optic cable is disposed within the channel such that the light emitted from the light emitting end is directed out of the front opening. The light receiving end can be optically coupled to a light source disposed within the light emitter housing. Alternatively, the light receiving end can be optically coupled to a remote light source. In another alternative, the channel opening can be disposed in the side or front side of the light emitter housing. A remote light source is described in United Kingdom Patent Application GB0606940.5, which was filed on Apr. 6, 2006, or co-pending U.S. patent application having attorney docket number 16516.2a, entitled “LIGHTING APPARATUS HAVING A LIGHTING COMPONENT HOLDER”, which patent applications are each incorporated herein in their entirety by specific reference.

In one embodiment, the illumination apparatus includes at least one lens disposed in the light emitter housing such that light emitted from the light emitter passes through the at least one lens. Such a lens or combinations of lenses can be any lens described herein or well known in the art.

In one embodiment, the light emitter housing and/or movable block can include an aperture or recess that is in the form of an elongate slot. Such an elongated slot is in optical communication with the channel, fiber optic cable, or light emitter disposed within the light emitter housing. The elongated slot can be positioned so as to have a longitudinal axis that can be arranged substantially horizontally with respect to the viewing aperture and/or viewing center axis.

In one embodiment, the movable block and/or light emitter can be movable relative to a part of the illumination apparatus body. The movable portion can move horizontally and/or vertically through any required angle with respect to the remaining part or parts of the illumination apparatus body.

In one embodiment, at least one angle indication means, such as an angle indicator, can be associated with each light emitter housing. Such angle indication means can be included with the light emitter housing in order to allow a user to determine the degree or position of the movable portion, such as the movable block or movable light emitter, with respect to the viewing axis or horizontal plane formed by the front opening in the illumination apparatus body. The angle indication means can allow a user to be able to reproduce the lighting conditions for a particular application, thereby providing accurate and reproducible results. The angle indication means can be a visual and/or audio indication, such as a clicking sound on movement of the movable portion and/or visual markings provided on a part of the housing. For example, the angle indication means can be angle indicia printed on the light emitter housing that identifies the angle of the emitted light with respect to the viewing aperture and/or viewing center axis. Angle indicators are well known in the art.

In one embodiment, the light source for the illumination apparatus can be provided remotely of or separately from the illumination apparatus. The light source is typically provided in its own housing or light box and can include any suitable light generating means such as LEDs, halogen, HID, or other lamp. Also, one or more filters and/or lenses can be associated with the remote light source housing and/or the fiber optic cable in order to filter out selected wavelengths of light. For example, the filters can filter out harmful radiation, such as ultraviolet light and/or infrared light. Examples of filters include an ultraviolet filter, an infrared filter, an orange filter, a polarizer filter, a wavelength filter, a long-pass filter, a short-pass filter, a tunable filter, and combinations thereof. The lenses can be used to focus the light in a suitable manner.

In one embodiment, a cooling system can be associated with the remote light source housing and/or with the housing of the illumination apparatus to ensure the apparatus does not get too hot during use. Optimally, the cooling system can be thermally coupled with, or disposed on the housing of the illumination apparatus. The cooling system can be configured similarly as described in the incorporated references or well known in the art.

With respect to the various embodiments of the illumination apparatus described herein, different components can be attached, affixed, or associated together. In the instance two or more different components are attached or otherwise connected, such an attachment or connection can be facilitated with a fastener or other attachment means.

In one embodiment, the illumination apparatus body includes at least first and second parts such as the first and second adaptors. The first part can be attached directly to the viewing device and the second part can be attached to the first part. The illumination apparatus body can be associated with the second part. The first and second parts can be detachably attached as required.

In one embodiment, the first part is attached to the viewing device, such as to the front of a camera lens arrangement, via a screw thread arrangement. The second part is attached to the first part via a magnetic pair. The magnetic pair can include one or more magnets, and further can be rare earth magnets, such as neodymium magnets.

According to another embodiment of the present invention, there is provided a camera (e.g., standard or digital camera), video recorder, or loupe including the illumination apparatus as described herein. The illumination apparatus can be configured or include the various components as described herein.

According to another embodiment of the present invention, there is provided a method of using illumination apparatus. Such a method can include illuminating an object with light emitted from the light emitter and viewing the object through the viewing aperture. Additionally, the method can include taking a photograph or video recording with the viewing device attached to the illumination apparatus. Further, the method can include transmitting the photograph or video recording to a facility to analyze the color of the object in the photograph or video recording. Furthermore, the facility or a professional can prepare a material to match the color, shade, hue, or other visual feature of the material to the object in the photograph or video recording. For example, the object can be a patient's teeth and/or previous dental restoration.

As described herein, the illumination apparatus of the present invention has the advantage that it is easy to use and provides substantially continuous and consistent illumination at the required color temperature suitable for color rendering. By providing continuous reproducible lighting, a photographer can set up the camera using desired settings much more reliably than using a flash since they can see the subject being photographed clearly prior to the image being captured. The apparatus also minimizes specular reflection, especially when the light is directed at an acute angle, such as 45 degrees, with respect to the object being illuminated. The illumination apparatus can be used for any medical or macro-photography application and/or the like.

### III. Exemplary Illumination Apparatus

The following figures describe embodiments of an illumination apparatus and/or a photography system having the illumination apparatus in accordance with the present invention. As such, the following figures illustrate and reference various components or elements of the illumination apparatus and/or photography system. While the figures are illustrated and described in connection with an illumination apparatus configured to be associated with a digital camera, the illumination apparatus can be configured for other uses.

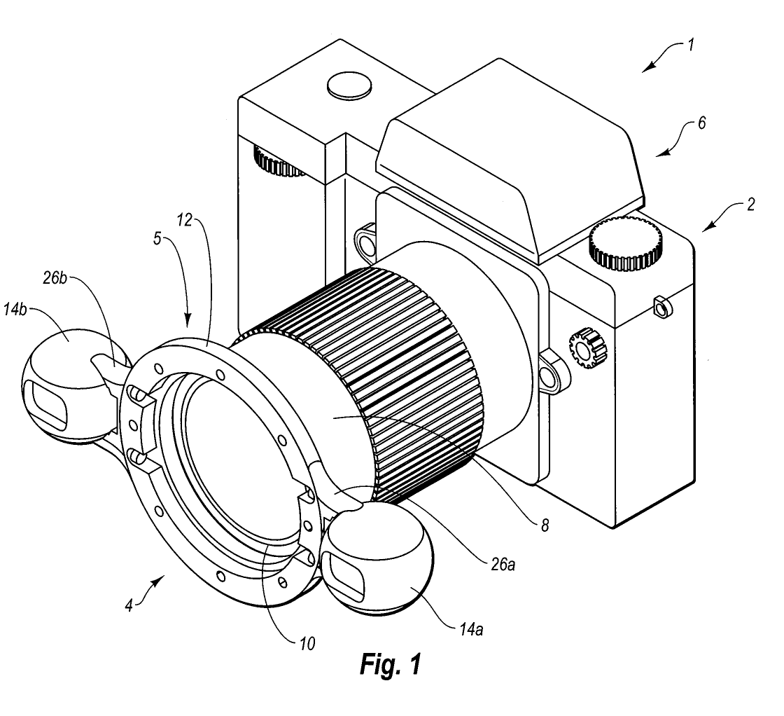

FIG. 1A is a schematic representation of a photography system 1 in accordance with the present invention. Such a photography system 1 can include a camera 2 and an illumination apparatus 4 as described herein. For example, the camera 2 is a digital camera having the illumination apparatus 4 coupled therewith to provide continuous and consistent lighting to allow accurate color rendering for taking photographs in a dental application. The digital camera 2 includes a camera body 6 and a lens arrangement 8 located on a front portion of the camera body 6. The lens arrangement 8 can be any lens arrangement, such as a standard or telephoto lens arrangement. Also, the lens arrangement 8 can be integrated with the camera body 6. As shown, the illumination apparatus 4 is attached to a front portion of the lens arrangement 8.

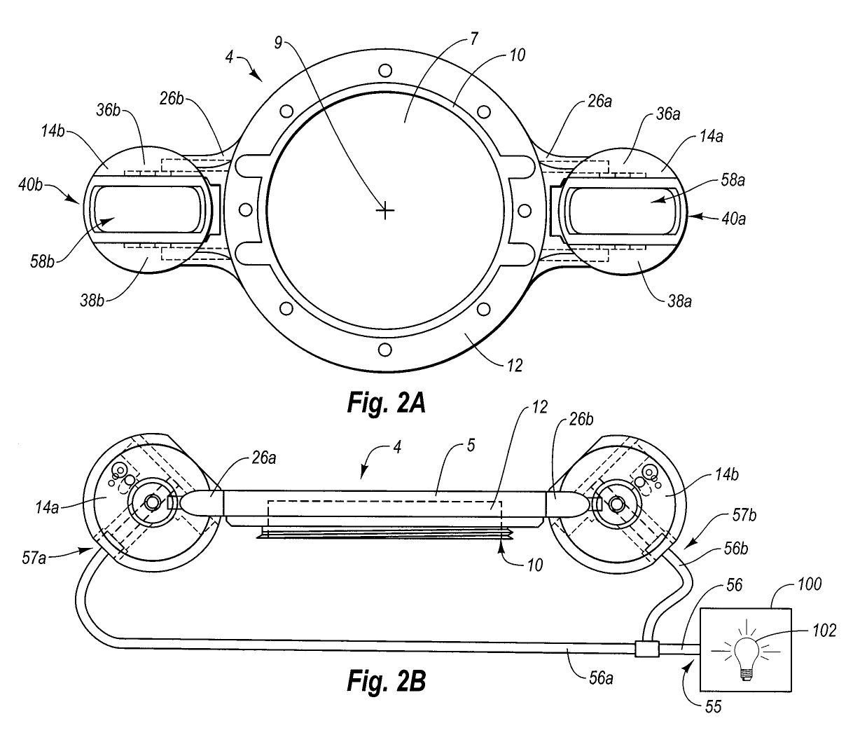

FIGS. 2A-2B illustrate an embodiment of the illumination apparatus 4 (also shown in FIG. 1). The illumination 4 is shown to include an illumination apparatus body 5 comprising a first adaptor ring 10 and a second adaptor ring 12. The first adaptor ring 10 is removably attachable to the lens arrangement 8, and the second adaptor ring 12 is removably attachable to the first adaptor ring 10. The illumination apparatus body 5 is substantially annular so as to define a viewing aperture 7 having a viewing center axis 9.

Additionally, two light emitter housings 14a-14b are disposed on opposite sides of the second adaptor ring 12 and/or illumination apparatus body 5. The light emitter housings 14a-14b are shown to be attached to the second adaptor ring 12 via mounting brackets 26a-26b. The light emitter housings 14a-14b are shown to be comprised of top caps 36a-36b and bottom caps 38a-38b. Additionally, the light emitter housings 14a-14b include movable blocks 40a-40b that define elongated slots 58a-58b, which are described in more detail below.

FIG. 2B illustrates an embodiment of an illumination apparatus 4 that includes fiber optic cables 56a-56b as light emitters. As shown, the fiber optic cables 56a-56b are shown to be extending from the back of the two light emitter housings 14a-14b. More specifically, the light emitting ends 57a-57b of the fiber optic cables 56a-56b are disposed within the light emitter housings 14a-14b.

Additionally, a light source 102 associated with fiber optic cable 56 is remotely located from the illumination apparatus 4 and is located in a conventional light box housing 100. Accordingly, a light receiving end 55 of the fiber optic cable 56 is optically coupled to a light source 102. The light source can be a HID lamp, such as a POV™ light. The HID lamp can be filtered for ultraviolet and infrared elements in the light box 100 using appropriate optical components, such as filters (not shown). The light receiving end 55 of the fiber optic cable 56 is located in the remote light box 100. The fiber optic cable 56 then splits into two separate cables 56a-56b to allow two light emitting ends 57a-57b to be attached to the light emitting housings 14a-14b, respectively. Thus, light passes into the light receiving end 55 of the fiber optic cable 56, along the fiber optic cables 56a-56b to be emitted from the light emitting ends 57a-57b and from the light emitting housings 14a-14b.

In one embodiment, a controller (not shown) can be associated or electronically coupled with the remote light source 102 or light box 100 to allow control of the light emitted from the light source 100. Alternatively, the controller can be associated with the illumination apparatus 4. Such a controller for controlling the light source 102 is well known in the art.

In one embodiment, the first adaptor ring 10 is screwed to the front of the camera lens arrangement 8 (FIG. 1) and the second adaptor ring 12 is magnetically attached to the front of the first adaptor ring 10. The movable block 40 is angled to a suitable angle, such as about 45 degrees, depending on how far the subject being illuminated is from the camera 2. An angle indicator (not shown) is associated with the light emitting housing 14a-14b in order to allow a user to set the angle of the light emitted from the fiber optic cable 56 with respect to the illumination apparatus body and/or the viewing axis. As such, a user can use pre-defined camera settings (e.g., configured to operate with the illumination apparatus), a pre-defined angle of light (e.g., 45 degrees) at a pre-defined color temperature (e.g., 5500 Kelvin) to provide accurate and reproducible results.

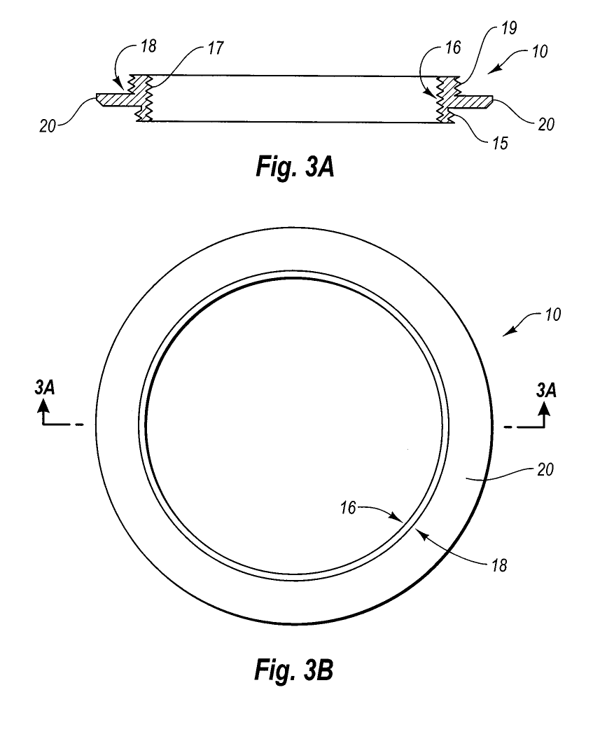

FIGS. 3A-3B illustrate an embodiment of the first adaptor ring 10. As such, the first adaptor ring 10 has an inner surface 16. The inner surface 16 has an inner screw thread 17 provided thereon to allow adaptor ring 10 to be screwed to the front of the lens arrangement 8 or to the second adaptor ring 12 by engaging in corresponding screw thread arrangements disposed thereon. Also, the first adaptor ring 10 has an outer surface 18 that has a front screw thread 19 and a rear screw thread 15, wherein the front screw thread 19 can be attached to a screw thread arrangement on the second adaptor ring 12 and the rear screw thread 15 can be attached to a screw thread arrangement on the lens arrangement 8 or vice versa. Additionally, the first adaptor ring 10 is shown to include a peripheral outwardly protruding flange 20 that is coupled on outer surface 18. The outwardly protruding flange 20 can be used to adjust the position of the second adaptor ring 12 with respect to the first adaptor ring 10. Also, the outwardly protruding flange 20 can be configured to engage with the second adaptor ring 12 engages, such as by including a part of a magnetic pair. Alternatively, the first adaptor ring 10 can include any of the features described in connection with the second adaptor ring 12.

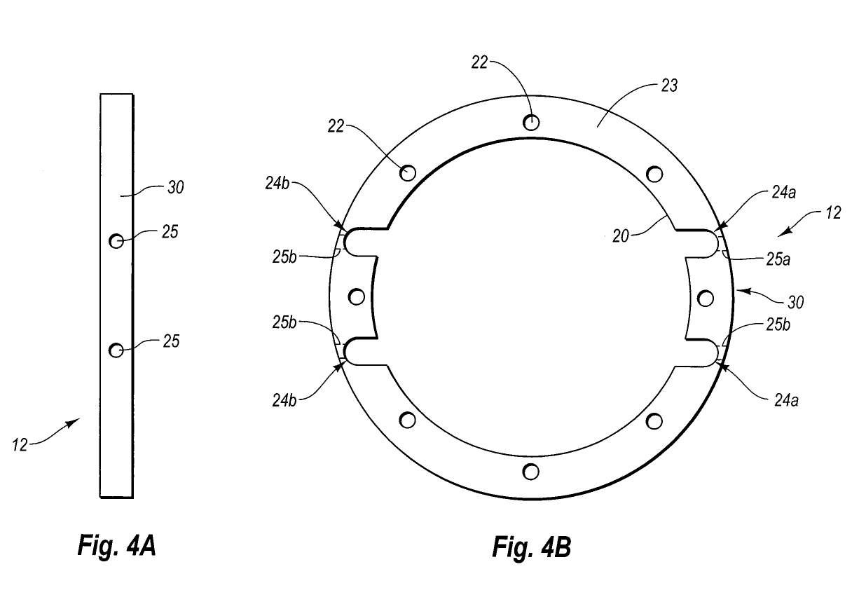

FIGS. 4A-4B illustrate an embodiment of the second adaptor ring 12. As shown, the second adaptor ring 12 is substantially annular in shape and includes an inner surface 20 and an opposite peripheral outer surface 30. The second adaptor ring 12 has a plurality of rare earth magnets 22 provided at spaced apart intervals on a rear surface 23 of the ring 12; however the magnets 22 could be disposed on any portion of the ring 12. These magnets allow detachable attachment of the adaptor ring 12 to flange 18 of the first adaptor ring 10. The first adaptor ring 10 can be formed from stainless steel or some other ferrous or magnetic material having opposite polarity to magnets 22 to allow engagement between adaptor ring 12 and adaptor ring 10, or vice versa. Alternatively, item 22 could also be holes or apertures for receiving a fastener to couple the second adaptor ring 12 to the first adaptor ring 10. Moreover, the second adaptor ring 12 can include any of the features described in connection with the first adaptor ring 10.

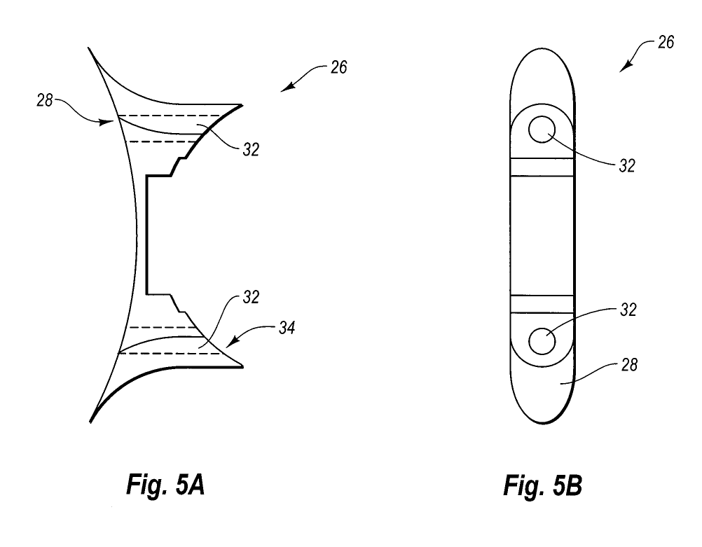

Additionally, the second adaptor ring 12 is shown to have two recesses 24a-24b defined in the internal surface 20 of each side of the second adaptor ring 12. The recesses 24a-24b can be associated with screw apertures 25a-25b at opposite locations to allow screw attachment of second adaptor ring 12 to first and second mounting brackets 26a-26b (see FIG. 1 and FIGS. 5A-5B).

FIGS. 5A-5B illustrate an embodiment of a mounting bracket 26 that can be used to couple the light emitter housing 14 to the second adaptor ring 12 and/or the illumination apparatus body 5. More particularly, each mounting bracket 26 has a first end 28 that is substantially concave in shape to allow location against the peripheral outer edge 30 of the illumination apparatus housing 5 and/or second adaptor ring 12. Additionally, the opposite second end 34 of mounting bracket 26 is substantially concave in shape to allow location of against any of the spherically-shaped light emitter housings 14a-14b. Each mounting bracket 26 includes at least one screw aperture 32 that can be aligned with the screw apertures 25 of the second adaptor ring 12. As such, the screw apertures 32 of the mounting bracket 26 can be provided at spaced apart intervals to allow screw attachment to the screw adaptors 25 of the second adaptor ring 12 and to the light emitter housings 14.

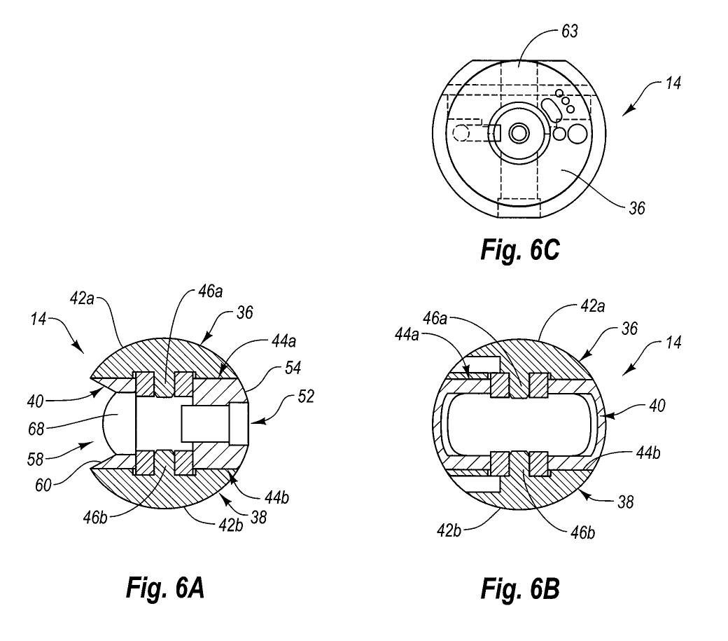

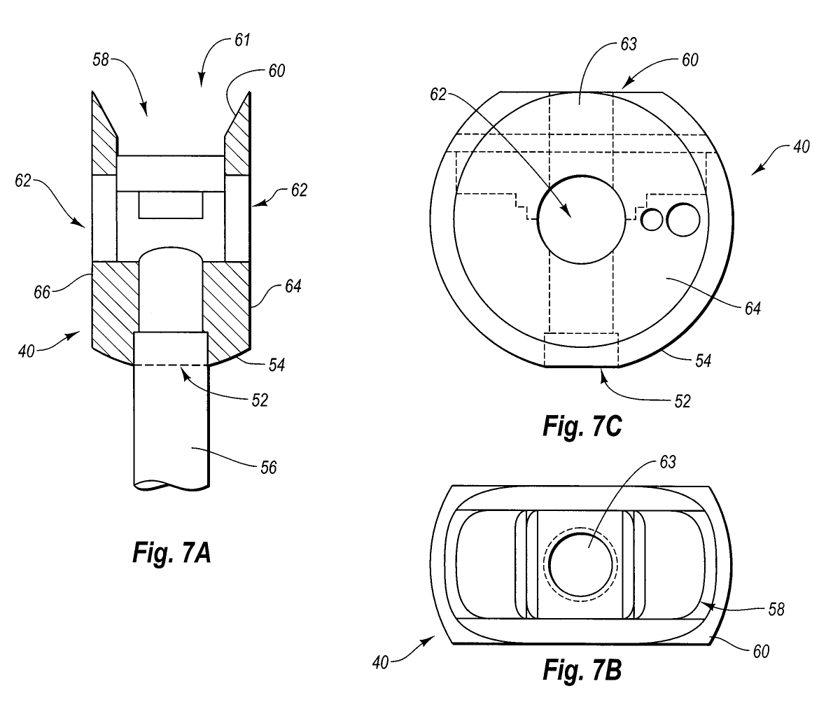

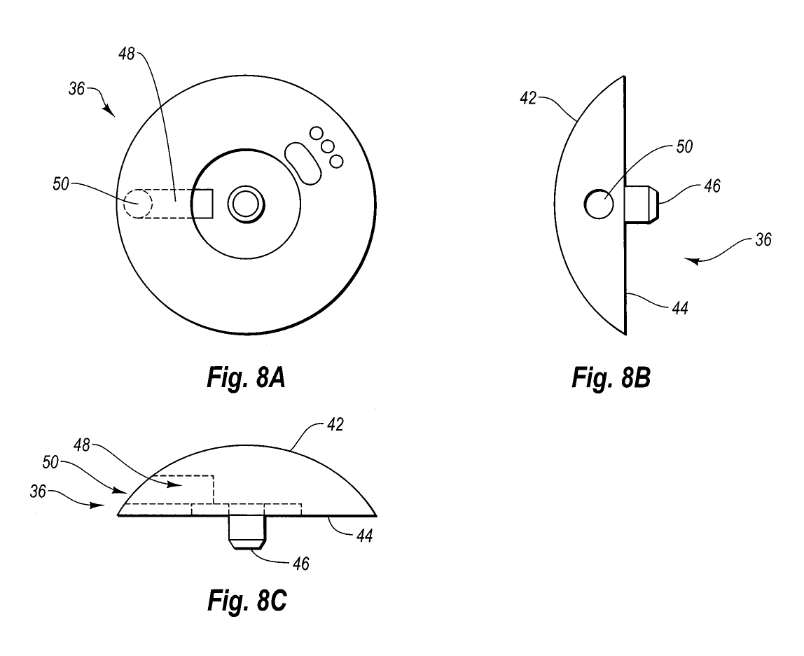

FIGS. 6A-6C illustrate an embodiment of a light emitting housing 14. As shown, each light emitting housing 14 is substantially spherical in shape and includes a top cap 36 and a bottom cap 38. Top cap 36 and bottom cap 38 can be configured to be substantially similar and are shown in more detail in FIGS. 8A-8C. Additionally, each light emitting housing 14 includes a movable block 40 (see FIGS. 7A-7C) disposed between the top cap 36 and the bottom cap 38.

As shown in FIGS. 6A-6C and 8A-8C, each cap 36, 38 is substantially hemispherical in shape with a curved outer surface 42 and a substantially planar inner surface 44. As such, top cap 36 has a curved outer surface 42a and a planer inner surface 44a, and bottom cap 38 has a curved outer surface 42b and a planer inner surface 44b. A rotation shaft 46a-46b is provided substantially centrally of planar inner surfaces 44a-44b for the top cap 36 and bottom cap 38, respectively. The rotation shaft 46 typically protrudes outwardly of planar surface 44.

As shown in FIGS. 8A-8C, the top cap 36 includes a channel 48 having an opening 50 on outer surface 42 that allows for attachment of the cap 36 and/or light emitter housing 14 to end 34 of the mounting bracket 26 (shown in FIGS. 5A-5B). Additionally, bottom cap 38 can be configured similarly as top cap 36. The caps 36, 38 are typically attached to the mounting bracket 26 so as to be at an angle of approximately 45 degrees or other angle with respect to the adaptor ring 12 and/or the illumination apparatus body 5.

As shown in FIGS. 6A-6C and 7A-7C, the movable block 40 is defined by a front surface 60, rear surface 54, top surface 64, and bottom surface 66. Each of the top surface 64 and bottom surface 66 includes a rotation shaft receptacle 62 that is configured to receive the rotation shafts 46a-46b of the top cap 36 and bottom cap 38, respectively. When assembled, movable block 40 can be rotated about a substantially vertical axis, typically between about 0 to about 180 degrees to allow the front elongate slot 58 to be angled at any suitable angle relative to the lens arrangement 8 (FIG. 1). This allows the light emitted through the fiber optic cable 56 from the light emitter housing 14 to be directed toward an object to be illuminated.

Additionally, movable block 40 has a rear opening 52 in rear surface 54 that connects to a front opening 61 of front surface 60 via a channel 63. The rear opening 52 can be configured to allow location of a light emitting end 57b of a fiber optic cable 56 (see FIG. 2b). As such, the fiber optic cable 56 can be disposed in the channel 63 such that light emits from the front opening 61 of the front surface 60. Additionally, an elongate slot 58 is defined in front surface 60 of the movable block 40 and is orientated substantially horizontally when the light emitting housing 14 is attached to the adaptor ring 12 and/or illumination apparatus housing 14. Elongate slot 58 is provided in association with front opening 61 and substantially opposite to rear opening 52 so as to allow light emitted from the light emitting end 57 of the fiber optic cable 56 to pass through the channel 63 and out the elongate slot 58. Moreover, FIG. 5A shows a lens 68 disposed in the elongate slot 58 at the front opening 61 so as to be optically coupled with the fiber optic cable 56.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An illumination apparatus comprising:
a first adaptor configured for being removably attached to a viewing device;
an illumination apparatus body removably coupled to the first adaptor, said illumination apparatus body at least partially defining a viewing channel having a viewing axis, said viewing channel extending from a rear surface to a front surface of the illumination apparatus body; and
at least one light emitter housing coupled to the illumination apparatus body and disposed laterally from the viewing axis, said light emitter housing comprising:
a light emitter body;
a movable block disposed in the light emitter body so as to be movable with respect to the light emitter body; and
a light emitter disposed within the movable block, wherein the movable block is movable so that light emitted from the light emitter is capable of being directed toward the viewing axis at a plurality of distances from the front surface of the illumination apparatus body.

2. An illumination apparatus as in claim 1, further comprising a second adaptor removably coupled to the first adaptor and integrated with the illumination apparatus body so as to couple the first adaptor to the illumination apparatus body.

3. An illumination apparatus as in claim 1, further comprising at least one mounting bracket coupled to the illumination apparatus body and coupled to the light emitter housing so as to couple the illumination apparatus body to the light emitter housing, said at least one mounting bracket being disposed in a position lateral from the viewing channel.

4. An illumination apparatus as in claim 1, comprising at least two light emitter housings that are disposed on opposite sides of the illumination apparatus body in positions lateral from the viewing channel.

5. An illumination apparatus as in claim 1, wherein the light emitter emits light characterized as substantially 5500 Kelvin.

6. An illumination apparatus as in claim 5, wherein the light emitter includes a plurality of LEDs that cooperate to emit the light.

7. An illumination apparatus as in claim 5, wherein the light emitter housing further comprises:
a channel defined by the movable block and extending from a rear opening in a rear surface to a front opening in a front surface of the movable block; and
a fiber optic cable disposed within the channel such that the light emitted from the light emitting end is directed out of the front opening of the movable block, said fiber optic cable having a light receiving end optically coupled to a remote light source.

8. An illumination apparatus as in claim 7, further comprising at least one of the following:
at least one lens disposed in the viewing channel;
at least one locking mechanism associated with the first adaptor that is configured to releasably lock the first adaptor to the viewing device;
at least one magnet disposed on one of the first adaptor or the illumination apparatus body and the other of the first adaptor or the illumination apparatus body being comprised of a magnetically responsive material that is magnetically attracted to the at least one magnet;
at least one lens disposed in the light emitter housing such that light emitted from the light emitter passes through the at least one lens; or
a rotation shaft coupled to the light emitter body that is rotatably inserted into a rotation shaft receptacle defined by the movable block such that the movable block is capable of rotating inward toward the viewing axis.

9. An illumination apparatus as in claim 8, wherein the viewing device is a lens device configured to be removably coupled to a camera or a video recorder and the first adaptor is annular and includes threads that screw into the lens device.

10. An illumination apparatus as in claim 8, further comprising a lens arrangement coupled to the first adaptor and to the viewing device, said lens arrangement being configured to be operable with the viewing device, said viewing device being a camera or a video recorder.

11. An illumination apparatus comprising:
a first annular adaptor configured for being removably attached to a viewing device;
a second annular adaptor removably coupled to the first lens adaptor;
an illumination apparatus body coupled to the second annular adaptor, said illumination apparatus body at least partially defining a viewing aperture having a viewing center axis, said viewing aperture extending from a rear opening in a rear surface to a front opening in a front surface of the illumination apparatus body;
at least one light emitter housing coupled to the illumination apparatus body or second adaptor and disposed laterally from the viewing aperture, said light emitter housing comprising:
a light emitter body;
a movable block disposed in the light emitter body so as to be movable with respect to the light emitter body;
a light emitter disposed within the movable block, wherein the movable block is movable so that light emitted from the light emitter is capable of being directed to the viewing center axis at a plurality of distances from the front opening of the illumination apparatus body.

12. An illumination apparatus as in claim 11, further comprising at least one mounting bracket coupled to the illumination apparatus body and coupled to the light emitter housing so as to couple the illumination apparatus body to the light emitter housing, said at least one mounting bracket being disposed in a position lateral from the viewing aperture.

13. An illumination apparatus as in claim 11, comprising at least two light emitter housings that are disposed on opposite sides of the illumination apparatus body in positions lateral from the viewing aperture.

14. An illumination apparatus as in claim 11, wherein the light emitter emits light characterized as substantially 5500 Kelvin.

15. An illumination apparatus as in claim 14, wherein the light emitter includes a plurality of LEDs that cooperate to emit the light.

16. An illumination apparatus as in claim 14, wherein the light emitter housing further comprises:
a channel defined by the movable block and extending from a rear opening in a rear surface to a front opening in a front surface of the movable block; and
a fiber optic cable disposed within the channel such that the light emitted from the light emitting end is directed out of the front opening of the movable block, said fiber optic cable having a light receiving end optically coupled to a remote light source.

17. An illumination apparatus as in claim 14, further comprising at least one of the following:
at least one lens disposed in the viewing aperture;
at least one locking mechanism associated with the first annular adaptor that is configured to releasably lock the first annular adaptor to the viewing device;
at least one magnet disposed on one of the first annular adaptor or the illumination apparatus body and the other of the first annular adaptor or the illumination apparatus body being comprised of a magnetically responsive material that is magnetically attracted to the at least one magnet;
at least one lens disposed in the light emitter housing such that light emitted from the light emitter passes through the at least one lens; or
a rotation shaft coupled to the light emitter body that is rotatably inserted into a rotation shaft receptacle defined by the movable block such that the movable block is capable of rotating inward toward the viewing center axis.

18. An illumination apparatus as in claim 17, wherein the viewing device is a lens device configured to be removably coupled to a camera or a video recorder and the first annular adaptor includes threads that screw into the lens device.

19. An illumination apparatus as in claim 17, further comprising a lens arrangement coupled to first annular adaptor and to the viewing device, said lens arrangement being configured to be operable with the viewing device, said viewing device being a camera or a video recorder.

20. A photography system for taking illuminated photographs under continuous light, said photography system comprising:
a camera;
a lens device configured to be removably coupled to the camera, said lens device having a lens housing including threads in a front surface of the lens housing; and
an illumination apparatus comprising:
a first annular adaptor having threads for being removably attached to the lens device by being screwed into the threads in the front surface of the lens housing;
an illumination apparatus body removably coupled to the first annular adaptor, said illumination apparatus body at least partially defining a viewing aperture having a viewing axis, said viewing aperture extending from a rear surface to a front surface of the illumination apparatus body; and
at least one light emitter housing coupled to the illumination apparatus body and disposed laterally from the viewing axis, said light emitter housing comprising:
a light emitter body;
a movable block disposed in the light emitter body so as to be movable with respect to the light emitter body; and
a light emitter disposed within the movable block, wherein the movable block is movable so that light emitted from the light emitter is capable of being directed toward the viewing axis at a plurality of distances from the front surface of the illumination apparatus body.

21. A photography system as in claim 20, wherein the light emitter emits light characterized as substantially 5500 Kelvin.

22. A photography system as in claim 21, wherein the light emitter includes a plurality of LEDs that cooperate to emit the light.

23. A photography system as in claim 21, wherein the light emitter housing further comprises:
a channel defined by the movable block and extending from a rear opening in a rear surface to a front opening in a front surface of the movable; and
a fiber optic cable disposed within the channel such that the light emitted from the light emitting end is directed out of the front opening, said fiber optic cable having a light receiving end optically coupled to a remote light source.

24. A photography system as in claim 21, further comprising at least one of the following:
at least one lens disposed in the viewing aperture;
at least one locking mechanism associated with the first annular adaptor that is configured to releasably lock the first annular adaptor to the viewing device;
at least one magnet disposed on one of the first annular adaptor or the illumination apparatus body and the other of the first annular adaptor or the illumination apparatus body being comprised of a magnetically responsive material that is magnetically attracted to the at least one magnet;
at least one lens disposed in the light emitter housing such that light emitted from the light emitter passes through the at least one lens; or
a rotation shaft coupled to the light emitter body that is rotatably inserted into a rotation shaft receptacle defined by the movable block such that the movable block is capable of rotating inward toward the viewing center axis.
